(19) United States
(12) Patent Application Publication
(10) Pub. No.: US 2006/0235726 A1
(43) Pub. Date: Oct. 19, 2006

(54) System and method for pharmaceutical item and prescription management

(76) Inventors: Lotmax Paraison, Medford, MA (US); Ronald Backer, Winchester, MA (US)

Correspondence Address: MAUREEN STRECTCH, 26 CHARLES STREET, NATICK, MA, 01760, US

(21) Appl. No.: 11/108,315

(22) Filed: Apr. 18, 2005

(51) Int. Cl. G06Q 10/00; G06Q 99/00; G06F 17/00

(52) U.S. Cl. 705/2; 705/51; 235/375

(57) ABSTRACT

A system for managing information about pharmaceuticals, patients and health care providers.

### BACKGROUND OF THE INVENTION

1. Technical Field

This invention relates generally to the field of pharmaceutical sample and prescription management.

2. Background

Physicians and other health care providers and institutions are faced with a complex set of requirements when prescribing and administering drugs and drug samples to patients.

In the United States, Federal and state laws and regulations obligate the health care provider to protect a patient's privacy, to comply with appropriate regulations for prescribing Federal Drug Administration (FDA_approved drugs, and to keep track of drug custody information. At the same time, malpractice litigation and litigation about adverse drug reactions mean that prudent health care providers need to know more about potential drug side effects and adverse drug reactions and interactions and need to make sure that patients are informed about the potential for these reactions. Health care providers also need to know whether their patients are adhering to their prescribed treatments and how effective these treatments are.

Pharmaceutical companies must comply with numerous laws and regulations and still find ways to market their drugs safely and successfully. Traditionally, providing physicians and health care providers with drug samples has been an effective way of getting drugs adopted for wider use and distribution. However, both litigation and regulation mean that these companies need much more timely information about the location, use, and efficacy of such samples than is currently available. At the same time, patient privacy requirements make this information harder to obtain.

Health insurance companies have an interest in keeping health care costs down and thus have developed what are known as drug formularies to let health care providers know which drugs are covered by that insurer's plans at one or more levels and which are not. If a provider prescribes a drug or gives a patient a sample that is not on that patient's insurer's formulary, this leads to increased costs for the patient and, in turn, that patient's dissatisfaction with the health care provider.

Finally, patients want to receive good and affordable health care. As health care costs rise, more and more patients are being asked to bear the brunt of the cost, especially in the cost of co-payments for prescription drugs. Anything that tends to make drug manufacturers and health care providers cut back on supplying free samples of drugs out of fear for regulatory or litigation problems, will increase costs further.

### BRIEF DESCRIPTION OF THE DRAWINGS

FIG. 1 is a schematic diagram of an overview of the system of the present invention.

FIG. 2 is a schematic diagram showing users interacting with the present invention.

FIG. 3 is a schematic diagram showing a table of roles used in the present invention.

FIG. 4 is a screen shot of a communications device of the present invention.

FIG. 5 is a schematic diagram of a set of database tables of the present invention.

FIG. 6 is a schematic diagram of an entry in the database of the present invention.

FIGS. 7-10 are flow diagrams of the present invention.

FIG. 11 is a schematic drawing of an outcomes graph of the present invention.

FIGS. 12-14 are screen shots of a communications device of the present invention.

FIG. 15 is a schematic drawing of an adherence graph of the present invention.

FIG. 16 is a screen shot of a communications device of the present invention.

FIGS. 17-21 are flow diagrams of the present invention.

### DETAILED DESCRIPTION OF THE INVENTION

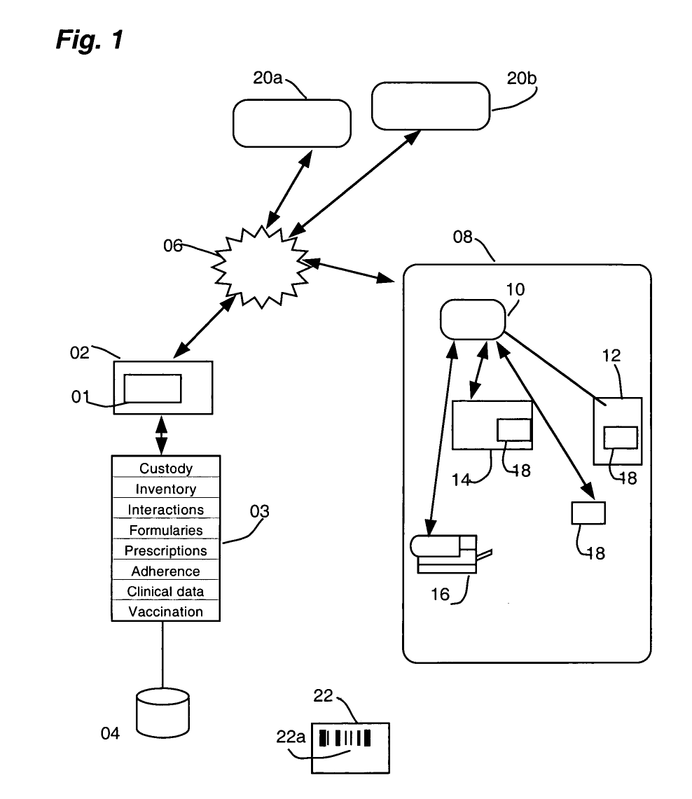

As seen in FIG. 1, the present invention in the embodiments shown, enables a health care provider 08 to use a communications device such as personal digital assistant (PDA) 12 or a personal computer 14, or similar device to communicate with a wireless router 10 or similar access point located inside that provider 08's firewall, and through that firewall, as appropriate, over the internet 06, to management system 01 operating in server 02 in communication with a database 04. Database 04, in turn is used to organize information relevant to functions such as pharmaceutical item (such as drug samples or any injectable item such as vaccines) chain of custody, an online inventory, a drug interactions database, insurance providers' drug formularies, a prescription writer function, patient adherence, clinical data observation and vaccination recall and drug refill information, with appropriate security measures to insure compliance with privacy mandates as is described in more detail below. Management system 01 is also capable of communicating with third parties 20 such as pharmaceutical manufacturers 20 or health insurers 20b.

Still in FIG. 1, as a health care provider 08 interacts with management system 01, the provider can use a communications device such as PDA 12 or personal computer 14 to scan or read in system-supplied drug sample information, patient chart information, vaccine information and so on.

Additionally, in the embodiments shown, the provider 08 can request that information about a drug sample and interactions be printed on local printer 16, or displayed on the communications device, such as PDA 12 or personal computer 14. Electronic signature capture devices 18 can be used by a patient to confirm that the drug sample information has been read and understood. In the embodiments shown, electronic signature capture device 18 can be as simple as the combination of a stylus for writing and the screen of a PDA 12 or personal computer 14, or sophisticated as a Bluetooth pen (using Bluetooth wireless technology as defined by the Bluetooth Special Interest Group) such as those manufactured by Logitech and others, or similar wireless pen technology, or an electronic signature reader similar to those used in retail stores, such as those provided by AxionTech and others. The advantage of a wireless pen, if used, is that paper forms can also be created at the same time, thus capturing a signature and other data both electronically and in hard copy. In the embodiments shown, devices that are capable of accepting or receiving some form of electronically generated signature are used, but those skilled in the art will appreciate that any form of electronic approval that can be accepted for audit and evidentiary purposes can be deemed an electronic signature without deviating from the spirit of the present invention.

Still in FIG. 1, in the embodiments shown, conventional PDAs, cell phones, computers, servers, printers, scanners, signature capture devices and databases are shown, as is the internet. However, those skilled in the art will appreciate that other devices or networking products could be used without deviating from the present invention. For example, instead of using a wireless router and wireless devices, wired devices could be used, as could private networks or virtual private networks, without deviating from the spirit of the present invention. Similarly, a variety of printers, PDAs, computers, laptop computers, cell phones, scanners, readers and similar devices are readily available on the commercial market and can be used without deviating from the present invention.

In FIG. 1, management system 01 insures that a system supplied identifier 22a, managed by system 01, is provided for each pharmaceutical item, whether it be a sample, a medication, or a vaccine managed by management system 01. In the embodiments shown, this may be implemented in a bar code or radio frequency identifier (RFid) or similar readable code affixed to or attached to the item. This solves a significant problem in tracking and identifying items from different pharmaceutical manufacturers. Presently, pharmaceutical manufacturers assign their own barcodes to such items and often may re-use barcodes previously assigned. Similarly, since individual manufacturers presently assign their own barcodes, they may or may not select identifiers which are unique and different from those of other manufacturers. Management system 01's identifier assignment insures that each individually packaged pharmaceutical item, such as samples, medications, vaccines, etc., managed by management system 01 will be identified in a way that can readily be scanned or read by barcode, RFid or similar coding and reading devices. This also enables management system 01 to track the chain of custody of the item throughout its lifecycle. In the embodiments shown, a pharmaceutical manufacturer can choose to use management system 01 to provide the manufacturer's identifiers 22a, or, alternatively, management system 01 can use a manufacturer's own identifiers, provided that they can be managed by management system 01 in cooperation with the manufacturer to insure uniqueness and the ability to label individual packets. If a pharmaceutical manufacturer does not use this feature of management system 01, the system still assigns system supplied identifiers 22a to samples and items transferred through management system 01.

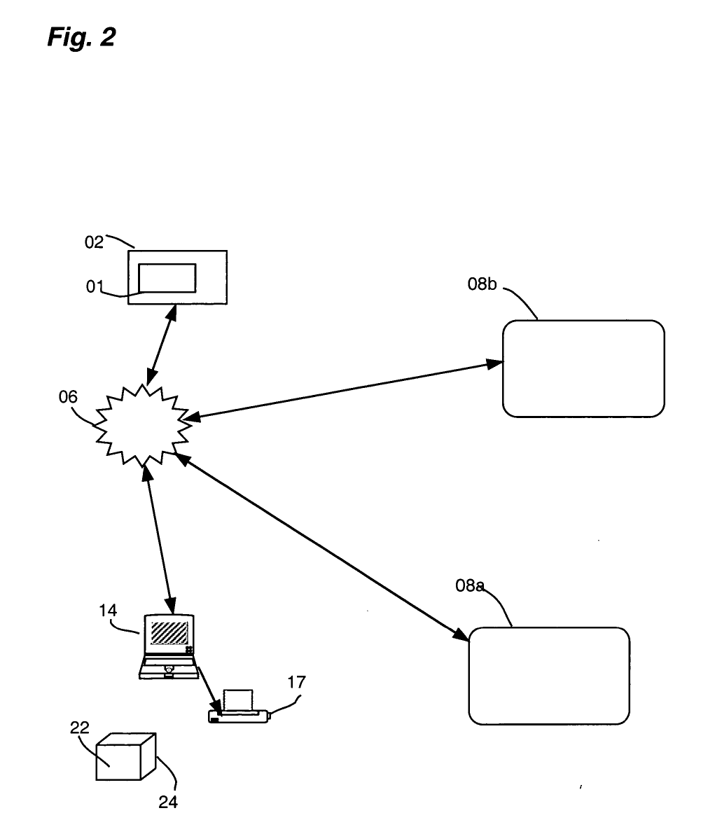

Turning briefly to FIG. 2, in the embodiment shown here, it can be seen that a pharmaceutical representative can use communications device, such as laptop computer 14, to communicate wirelessly with management system 01 over the internet 06, in order to obtain a list of system supplied identifiers 22a for the individually packaged samples 22 contained in a box 24 of samples the representative carries with him or her. The representative can inform management system 01 that a set of samples is being given to a particular provider 08a. In the embodiments shown, management system 01 will assign a set of system supplied identifiers 22a to the samples 22 which have been selected for transfer by the pharmaceutical representative.

These system supplied identifiers 22a can be physically and logically associated with samples 22 in several ways. In one embodiment, pre-printed barcode or RFid labels, or similar labels can be created (or purchased) and logged in by management system 01. This is a more economical implementation, as pre-printed labels can be produced or purchased in large quantities and frequently with better quality than labels printed on-site at a doctor's office. Zebra® Technologies, Inc., among others, provides a number of printers capable of printing large quantities of labels as well as desktop or mobile label printers. Alternatively, as the representative dispenses the samples 22 to a local health care provider 08a, the representative can print out the system supplied identifiers 22a on a small barcode label printer or RFid insertion device 17 communicating with laptop 14, and then affix these labels to the samples 22 for that health care provider 08. At this point, management system 01 has already assigned those system supplied identifiers 22a to this representative, as the first link in the chain of custody.

Still in FIG. 2, when the representative provides the health care provider 08a with the individually packaged samples 22 labeled for that provider 08, the representative uses management system 01 to transfer custody for that selection of drug samples 22 to that provider 08, as is discussed in more detail below.

Returning now to FIG. 1, the health care provider 08 or a staff assistant uses management system 01 to accept or reject the sample transfer in whole or in part, as will be discussed in more detail below. In the embodiments shown, provider 08 indicates acceptance of samples 22 by electronic signature, using one of the signature methods described above. If provider 08 accepts the transfer, the provider 08 or a staff assistant scans or reads in through provider 08's local communications device, such as PDA 12, the system supplied identifiers 22a into that health provider 08's online inventory of samples 22 stored in database 04 and confirm receipt of them. Those skilled in the art will appreciate that the health care provider 08 may have authorized one or more staff personnel to accept samples 22 and sign for them, according to local office practice.

In the embodiments shown, once a transfer lot is placed in the system and is accepted by a provider, it can no longer be deleted from database 04. A provider may delete a drug transfer lot in whole, if the provider does not want to accept any of the samples, but once the status has been changed to “transferred to provider”, the provider can no longer delete the item and any checkboxes or options for attempting to do so are disabled by management system 01 when it presents data about a transferred lot to the provider's communications device.

Still in FIG. 1, it should be noted that management system 01 enables a health care provider 08 to indicate whether the samples 22 being accepted are accepted for use in the office or for personal use. In all cases, management system 01 requires health care provider 08 to account for the disposition of accepted samples 22.

Still in FIG. 1, the present invention provides a chain of custody module which enables the health care provider to log in receipt of drug samples from pharmaceutical representatives, as described above, and to keep track of the distribution of these samples to patients. In the embodiments shown, and as will be described in more detail below, the present invention also enables the provider to scan in system supplied identifiers 22a (such as RFID codes, barcodes etc.), from each patient's chart or—in a hospital or clinic setting—an ID bracelet. That is, not only does management system 01 provide for the use of system supplied identifiers 22a for pharmaceutical items such as samples, medications and injectable items such as vaccines, these can also be provided to identify patients as well. Typically, a participating health care provider 08 would request a series of system supplied identifiers 22a for that provider's patient charts or files. Labels containing these system supplied identifiers 22a for patients can be attached to the patient's folder, (usually a manilla file folder or similar hard copy file) or printed as patient id bracelets. In this way, each patient is uniquely identified in a way that management system 01 can use to manage data relevant to that patient.

Continuing in FIG. 1, after the physician has arrived at a diagnosis for the patient and decided to prescribe a medication, the physician can use a communications device such as PDA 12 to check electronically to see whether a sample 22 of the medication is available in the physician's or clinic's inventory. If it is, the physician can then scan in the patient system supplied identifier 22a from the patient's chart, update the electronic version of the patient's chart stored in database 04, and then scan in the system supplied identifier(s) 22a of the sample dose(s) from the physician's physical drug closet which the physician wishes to provide to the patient.

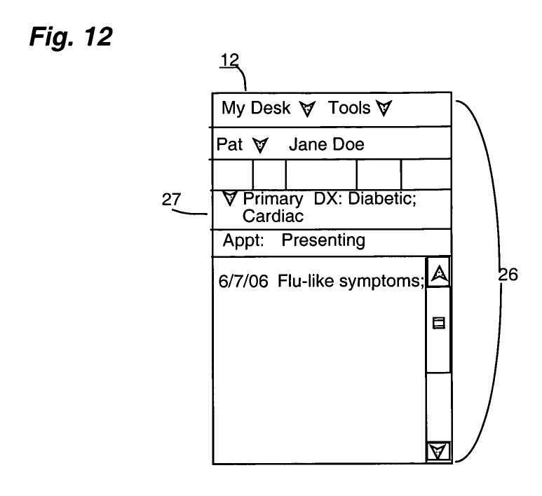

It is an aspect of the present invention that when it displays a patient's information, the system will also display that patient's most significant medical features or diagnoses, such as diabetic, pregnant, heart patient, as can be seen in FIG. 12, and as will be described in more detail below. The present invention performs an interaction and contraindications check to see if the medication conflicts with the patient's current health status or medical therapy. For example, some drugs are known to interact adversely with others or with certain foods.

Similarly, some drugs are contraindicated if the patient already has certain known medical problems, such as diabetes, liver ailments, or allergies to certain types of drugs. If there is a potential problem, management system 01 of FIG. 1 alerts the physician immediately. Thus, the present invention helps to minimize errors in identifying the patient and in prescribing for the patient. If the physician prescribes the sample 22 medication, the system will print out or display directions and any applicable warnings for the patient. After the patient has seen these directions and warnings, the physician can ask the patient to confirm reading them by using the electronic signature capture device 18. As mentioned above, this electronic signature capture device 18 may already be an integral part of a communications device, such as a PDA 12, which can capture a signature made with a stylus as a set of pixels for storage in database 04. In the embodiments shown, the present invention will then store the signature with the patient's information in a transaction log in database 04, and update the virtual drug inventory online for that provider 08 by showing that custody of the sample has been transferred to this patient. The entire transaction will also be given a system supplied identifier by the present invention for audit purposes. It is an aspect of the present invention that management system 01 will not permit certain records or items of information, such as acceptances of samples 22 or transaction logs, to be changed. This process, including the transaction log and the capture of patient and provider signatures can significantly mitigate the potential for malpractice problems and claims.

In the United States, there are several thousand drugs available for the treatment of diseases. The average doctor or health care provider typically uses and knows about only a small fraction of this total. In the United States, the Federal Drug Administration adds more medications to its approved list everyday, making it a difficult task for health care providers to keep up with the latest improvements. In addition, while physicians and other health care providers do possess some general knowledge about how chemical compounds used in drugs interact with each other, this is usually limited to those drugs with which the provider is most familiar. The present invention uses data about drug/drug interactions and drug/food interactions provided by the First Data Bank corporation to perform its interactions and contraindications checking, as is described in more detail below. Those skilled in the art will appreciate that other data sources could be used without deviating from the spirit of the present invention.

Still in FIG. 1, as mentioned above, health insurance companies use drug formularies to define which drugs are covered by that insurer's plan, and to what extent. Typically, an insurer will have several tiers of coverage. For example, Tier 1 might be 90% coverage. Tier 2 might be 80% coverage or a specified co-payment level, and so on. If a physician provides a patient with a sample of a given drug and a prescription for it as well, it can be costly for everyone if the drug is not covered at all in the patient's insurer's formulary. When the patient tries to get the prescription filled at a pharmacy, the pharmacist will usually check to see if that drug is covered by that patient's insurer. If it is not, the pharmacist must inform the patient. The patient, in turn, may call the doctor to request that the doctor prescribe a different drug. All involved have to repeat steps that have already been taken. The present invention saves both time and money by checking to see if samples or prescriptions are covered by a patient's insurer and notifying the health care provider at the outset if they are not, so that a formulary override can be generated by the health care provider, if desired.

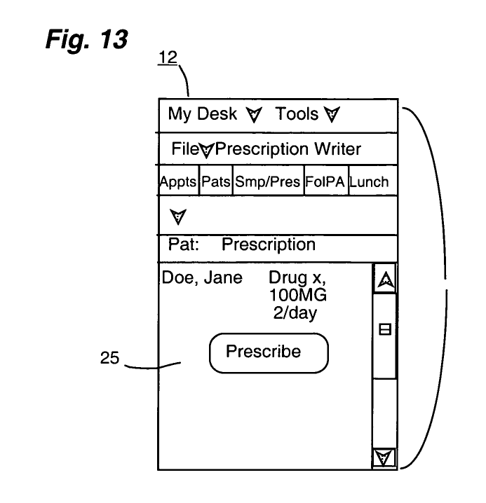

Still in FIG. 1, the present invention also provides the health care provider 08 with an electronic prescription writer. Often, when a physician hands out samples 22, the physician will also provide the patient with a prescription for the remaining doses needed to complete therapy with that drug. The present invention eliminates the need for the physician to do this manually by writing on a prescription paper pad. Instead, the physician can simply click an indicator displayed by the system, as seen in more detail in FIG. 13, to create a complete prescription along with instructions. The prescription, in turn, can be printed out for the patient, or sent by email or facsimile to the patient's pharmacist.

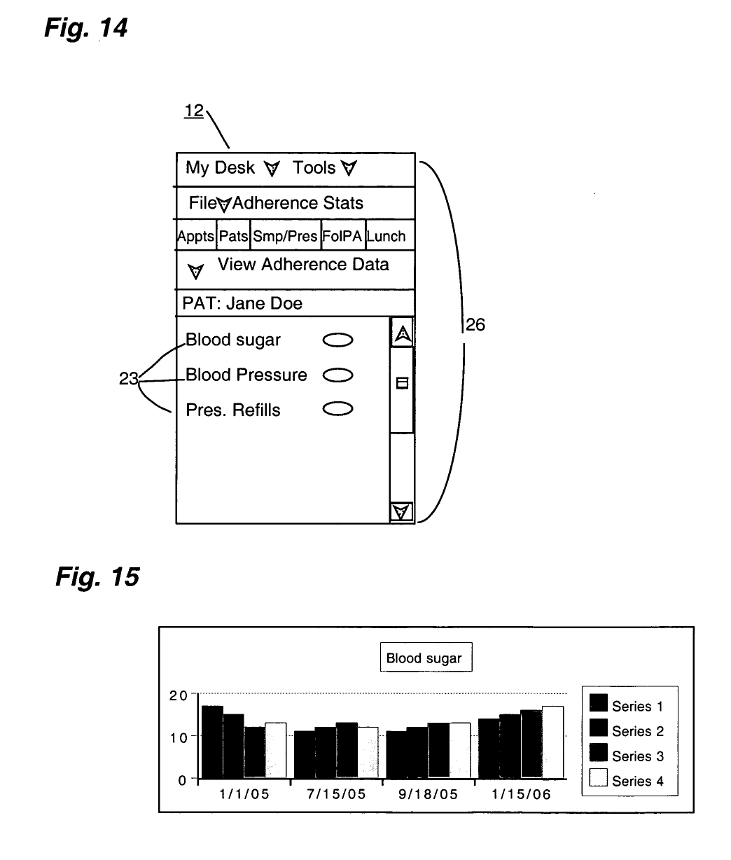

Returning to FIG. 1, the present invention also provides the health care provider with tools to use to ascertain whether the patient is adhering to the prescribed regimen. This is most important for special or chronic conditions, such as diabetes, pregnancy, high blood pressure, arthritis, and so on. Turning now to FIG. 14, using a communications device such as PDA 12, a health care provider may request adherence data for a specific patient by clicking on the indicator for that data. With reference now to FIG. 15, a bar chart displaying that patient's test results for blood sugar values over the past year are shown. In this example, it can be seen that the patient's blood sugar level has been increasing slightly over the year, which indicates that the patient's adherence may be slipping and may require more interaction between the patient and the physician. Management system 01 allows a provider 08 to indicate, as appropriate, that the patient has been reminded at a visit to check her blood sugar more often. This will be entered in the transaction log for that patient.

Adherence is an important feature for several reasons. First of all, the patient's good health usually depends upon it. Second, many insurers are now changing their care models to emphasize prevention. An insurer may now give a physician an extra 50% reimbursement per patient per month if the doctor makes sure that all diabetics check their blood sugar daily, etc. Management system 01 makes it easier for a doctor to show that these preventive measures have been taken.

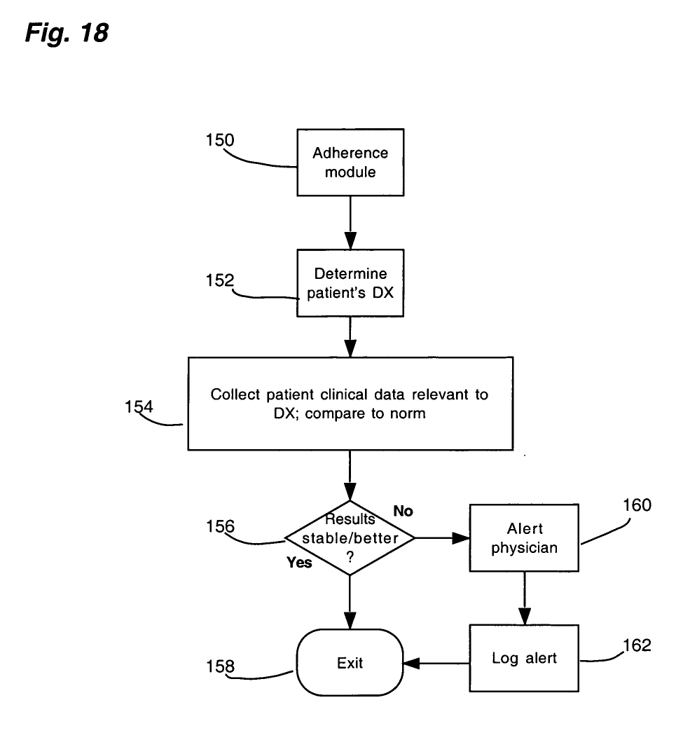

FIG. 18 is a flow diagram of the adherence data gathering module of the present invention. At step 150, the module is entered and at step 152 it determines the correct International Classification of Diseases—ICD codes for the patient's diagnosis based on the request made by the health care provider. At step 154, the adherence data gatherer collects the relevant patient clinical data ( for example, blood sugar values, vital signs, prescription refills, etc.) stored in database 04 for that patient and related to that ICD code and compares that data to the data for normal healthy subjects. If the results indicate that the patient is stable or improving compared to the norm, processing exits at step 158 with an indication that results are the same or better. However, if the results are becoming worse than a predefined range, the adherence data gatherer will alert the physician at step 160 and log the alert at step 162.

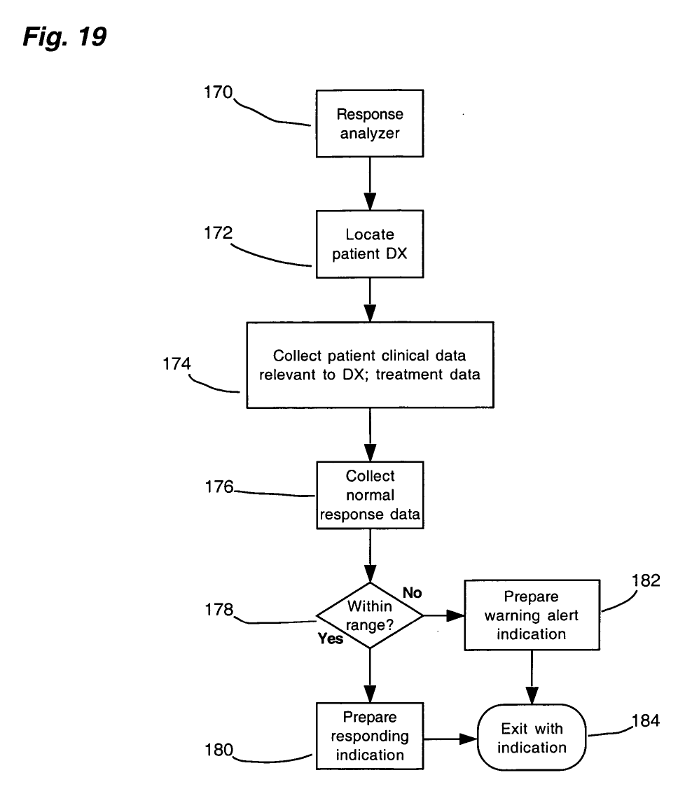

Turning now to FIG. 19, the response analyzer of the present invention is shown being entered at step 170. At step 172 the response analyzer locates the ICD code for the request for this patient and at step 174, the invention collects the patient clinical data relevant to that ICD code, and the treatment data for the patient. For example, if the diagnosis is bronchitis, the relevant clinical data might include values from two or more complete blood counts (CBCs) showing white blood cell counts. The treatment might include a specific antibiotic. At step 176 the response analyzer collects normal response data for that ICD code and treatment. In a hypothetical example, one antibiotic may typically reduce infection significantly within 48 hours, which is usually indicated by a reduction by half in the number of white blood cells showing up in a CBC. At decision block 178, the response analyzer checks to see if the patient's response is within some predetermined range close to the normal response. If it is, an indication is shown when the analyzer exits at step 184. If the patient's response is not within the predetermined range, this is indicated at step 182 and so upon exit.

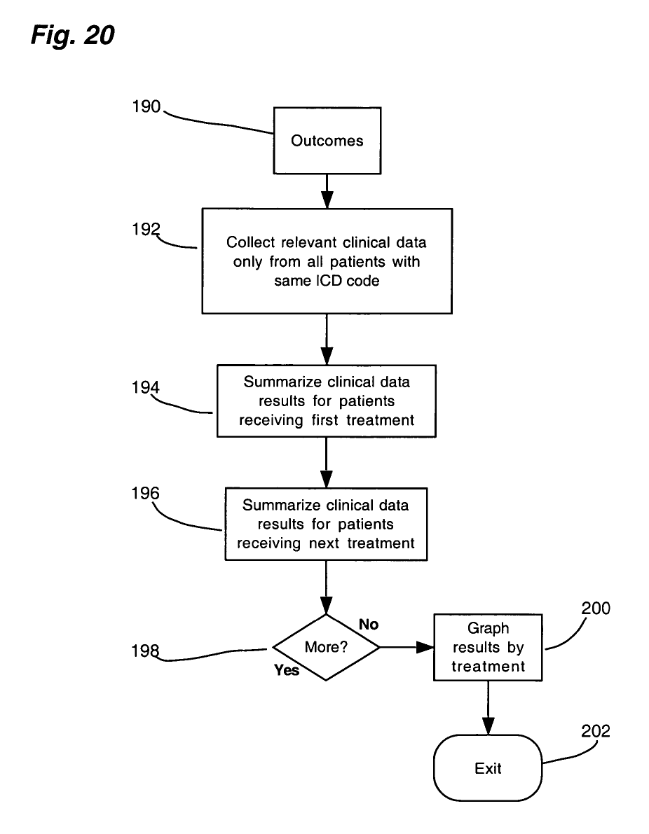

With reference now to FIG. 20, the outcomes analysis of the present invention is shown. At step 190, an outcomes analysis has been requested and at step 192, the outcomes analyzer collects the relevant clinical data (without any identifying patient data), from all patients in the specified group having the same ICD code. At step 194, the clinical results for those patients receiving a first specified drug or treatment are summarized, and then the results for those receiving the next treatment are summarized at step 196, and so on, with the results indicated by graph at step 200.

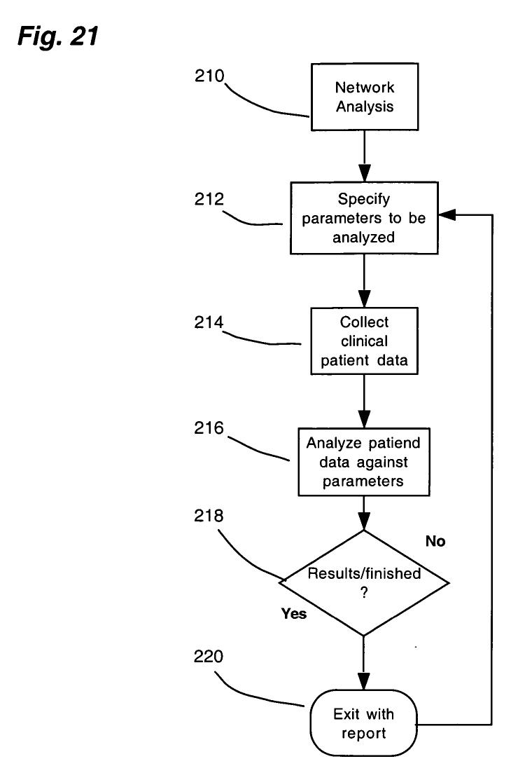

Management system 01 of the present invention can also provide assembled observations data to health care providers. This function uses network analysis programs to review data about previously unreported reactions and possible adverse interactions to prescribed, over-the-counter, or alternative remedies and specific disease states using ICD-9 codes associated with specific pharmacotherapeutic remedy interactions. In the embodiments shown, the UCINET software from Analytic Technologies, Inc. is used, but those skilled in the art will appreciate that similar programs from others could be used without deviating from the present invention. Use of network analysis is depicted in FIG. 21. At step 210, a network analysis is requested and at step 212, the user specifies the parameters to be analyzed (e.g. particular ICD codes and specific treatments and specific reactions) to the network analysis program. At step 214, the user designates the type of clinical data to be collected without disclosing patient identities, and then at step 216, runs the network analysis program to analyze the specified parameters against the specified clinical data. At decision block 218, the user can decide whether the results from the program are significant or not and proceed accordingly.

Still in FIG. 1, management system 01 in the embodiments shown, also makes it possible for a health care provider to review a patient's clinical response to prescribed samples and treatments and compare these with predicted responses. This aspect of the invention makes use of clinical data reports, laboratory results, electro physiologic, pulmonary, nuclear and other pertinent studies and reports stored in database 04 to visualize in graphs how the patient's response compares to the norms for those same items stored in reference tables in database 04 as described above.

Still in FIG. 1, yet another function provided by management system 01 is management of pharmaceutical items such as vaccinations and refills. Currently, many devices such as syringes for vaccines can be coded with RFID or similar identifiers so that they may be checked for expiration, dosage levels, recalls and so on. The present invention, by providing system supplied identifiers 22a for such vaccinations and syringes permits the health care provider to scan such a device to verify that it provides the proper dosage, has not been recalled, etc. This is also an example of the use of management system 01 for non-human health care, such a veterinary practices, where vaccinations and vaccination records are also important.

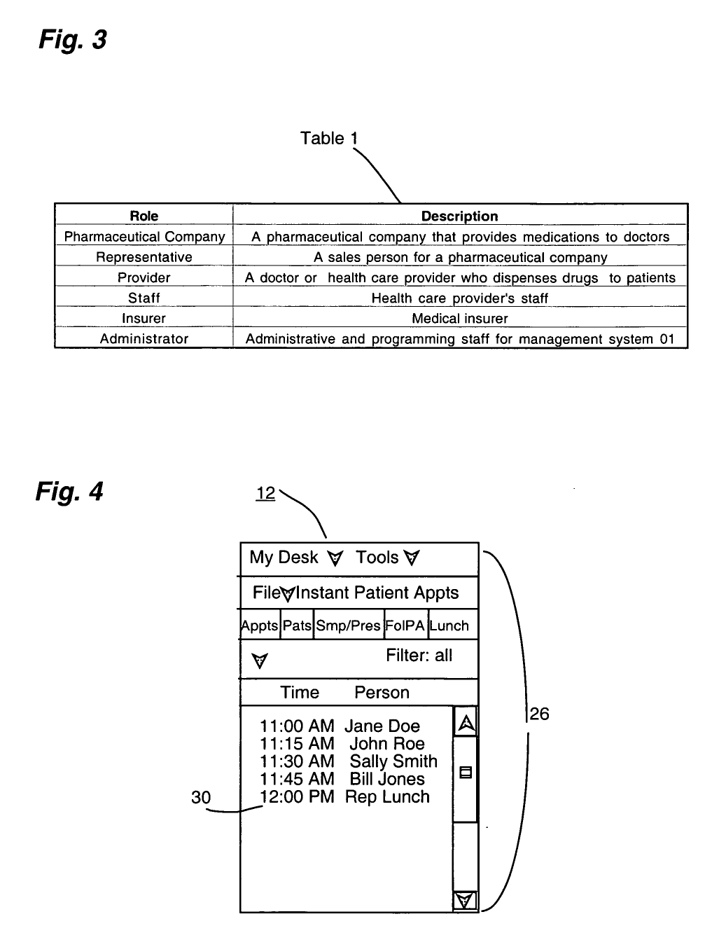

With reference now to FIG. 3, management system 01 assigns roles to different types of users as seen in Table 1 of FIG. 3. When a user logs into management system 01 via a communications device such as a PDA 12 or computer 14 or a cell phone, or similar device, management system 01 determines what role that user has been assigned in the system and based upon this role, that user will be able to access only those menus and data items that are permitted to that role and that particular user. The present invention also provides a second level of access by allowing users to assume membership in different groups. For example, a doctor may belong to a doctor's office with several other doctors, all sharing the same physical drug sample inventory. Normally, a doctor in such a group will see only his or her own patients. However, the doctor may also be able to see other patients who see other doctors in the same office. Also, in case of an emergency, a doctor in the office may need to see information on other patients in the office. Management system 01 permits such access as required and records each access in an audit log. Similarly, an entity's role in management system 01 can also be used to assist in processing various transactions. For example, in the embodiments shown, as a pharmaceutical item such as a sample 22 is transferred from a pharmaceutical representative to a health care provider, the respective roles of these two entities can be used to locate inventory files for each in database 04 and adjust them accordingly.

Turning now to FIG. 4, another aspect of the present invention is shown. In FIG. 4, an exemplary screen shot 26 from a PDA 12 communications device is shown. In this example, a list of appointments for this provider 08 is shown for the day on screen shot 26. Management system 01 provides an appointment scheduling feature for the users of the system to enable providers 08 to schedule and check appointments with their patients and to enable pharmaceutical representatives to schedule and keep appointments with providers 08. Since physicians and health care providers are so busy, they usually limit the time they can make available to pharmaceutical representatives to discuss drug samples. When time is available, a physician may allow the representative a luncheon appointment to meet with the doctor(s) and doctor(s)' staff to discuss new medications and samples being distributed to the doctor by the representative.

In FIG. 4, such a luncheon appointment is shown at line 30. Typically, at such luncheons, the pharmaceutical representative will talk with the doctors and staff to inform them of the products offered by that company and the benefits of the products. To aid in this effort, the pharmaceutical representative will usually distribute drug samples 22 to the doctor, using the present invention. Such samples 22 benefit the doctors because it means a patient may use the sample until the patient has time to get a prescription filled at a pharmacy. It also reduces the cost to the patient, and once the patient has tried a drug by using a sample, the patient may be more likely to prefer this drug treatment and request it from the doctor, thus ultimately benefiting the pharmaceutical manufacturer. The present invention significantly reduces the costs and risks of distributing samples, by providing the safeguards needed to make it an effective process for all concerned.

Still in FIG. 4, it is an aspect of the present invention that its screen displays are designed to be shown via XML on both conventional computer and laptop displays as well as the smaller displays of PDAs, cell phones etc.

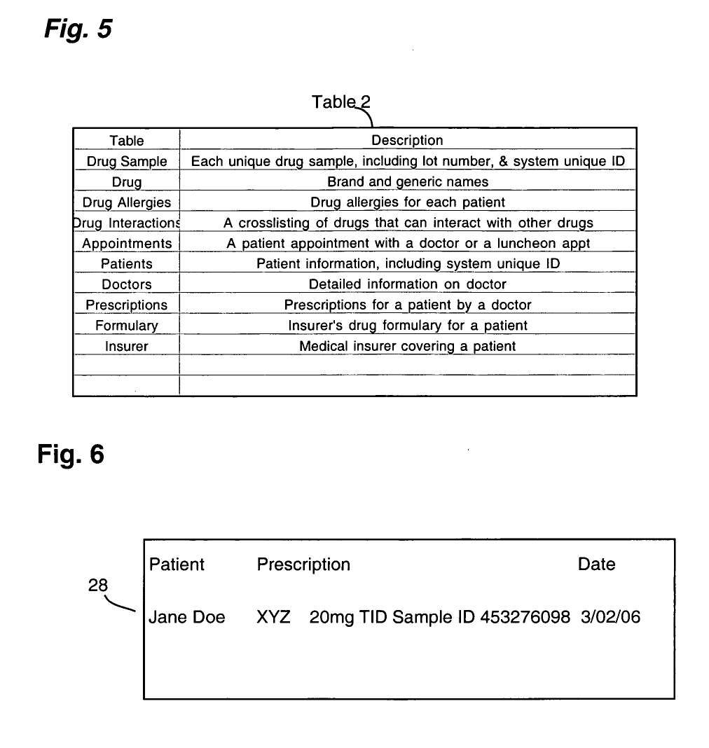

With reference now to FIG. 5, Table 2 shows some of the tables used in database 04 of the present invention. In the embodiments shown, database 04 is created using the freeware relational database software PostGres, which relates stored data in tables. Those skilled in the art will appreciate that similar database programs such as My SQL can be used, as can more robust commercial databases such as Oracle's Oracle database, or IBM's D2, etc.

In FIG. 6, an illustrative data entry 28 in database 04 is shown, listing a patient, the drug prescribed, the fact that a sample was provided on a particular date and also including the system supplied ID 22a of the sample provided.

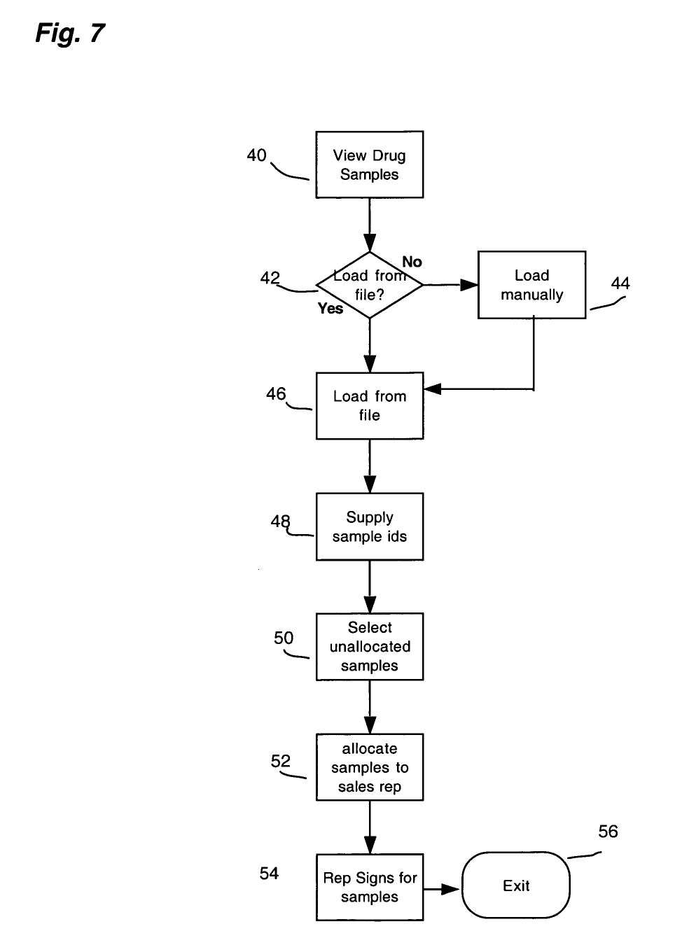

Now turning to FIG. 7, a flow diagram of an initial phase of the custody module of the present invention is shown. As seen at step 40, management system 01 is used to view a set of pharmaceutical items, such as drug samples which a pharmaceutical company wishes to assign to a particular sales representative. As indicated by decision block 42, these items can either be entered manually, at step 44 or loaded into management system 01 and database 04 from a file at step 46. Once the items have been loaded into management system 01 and database 04, carrying the manufacturer's identifiers and information, management system 01's custody module selects system supplied identifiers 22a for each item at step 48. In the embodiments shown, the system supplied identifiers 22a are created by using a master table of identifiers for each type of labeling mechanism, such as bar codes, RFid's, etc. As an identifier is selected from the table, it is permanently locked and made unavailable for reuse. Those skilled in the art will appreciate that these system supplied identifiers 22a can be created in advance for use in purchasing or pre-printing labels, and then associated or assigned to a representative either at the time the representative takes physical custody of the items, or when the representative transfers them to a health care provider 08.

Still in FIG. 7, at step 50, the pharmaceutical company user can select unallocated pharmaceutical items 22 and allocate them to a particular sales representative at step 52. The system supplied identifiers 22a which have been assigned to those items will now be reflected in that sales representative's inventory of items as stored in database 04. Alternatively, these items can be associated with the representative when the representative actually transfers them to a provider 08.

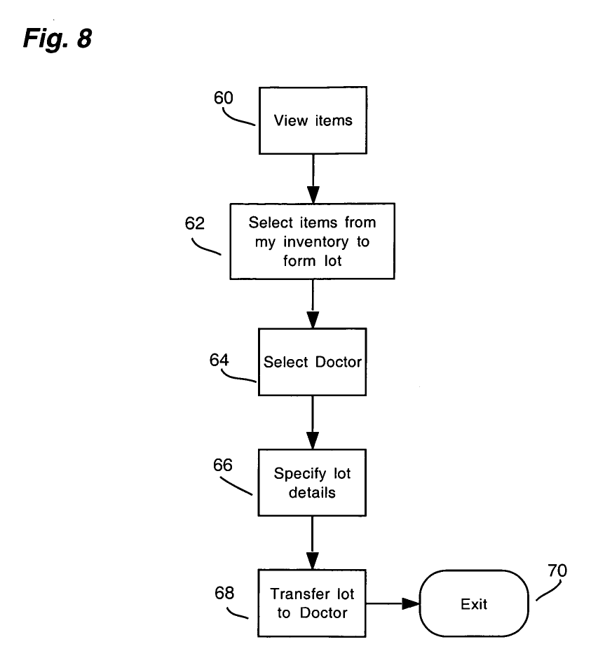

Now in FIG. 8, the steps used by a representative to transfer pharmaceutical items such as samples or vaccines to a doctor or similar health care provider 08 are shown. At step 60, the representative views the pharmaceutical items and at step 62, selects one or more items from that representative's own inventory to form a lot being transferred. Next, at step 64, the representative selects a doctor to whom this lot will be transferred, and at step 66, the representative specifies details about the lot being transferred, such as manufacturer's lot number, drug name, dosage, expiration date and so on. Finally, at step 68, the representative uses management system 01 to transfer the lot to the selected doctor and then exits at step 70. Note that at this point, the doctor has not yet accepted the transfer. In the embodiments shown, at this point, the representative will have the labels containing the system supplied identifiers 22a for each individually packaged item in the lot and have attached, affixed or adhered those labels to the items.

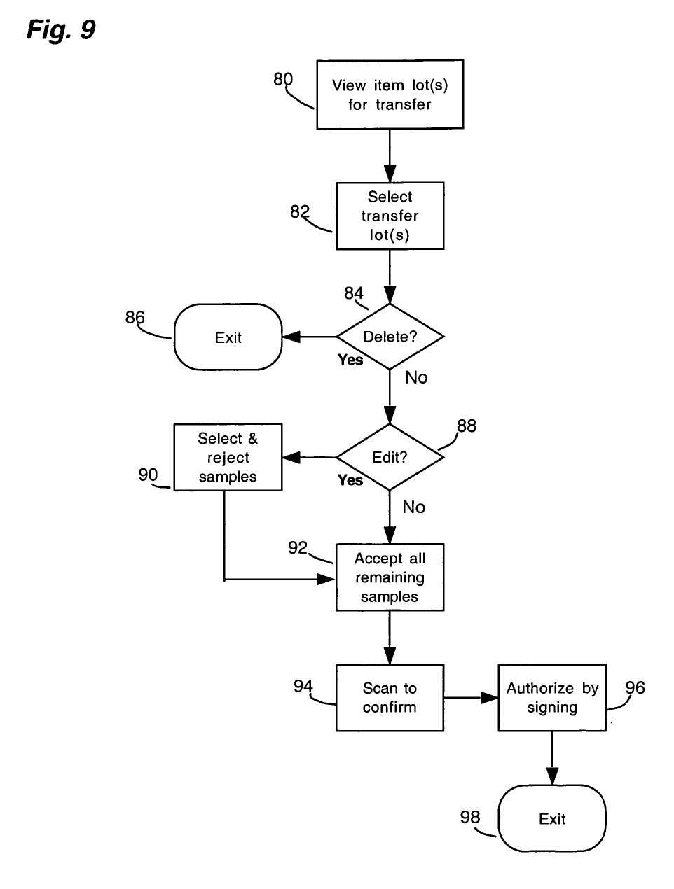

With reference now to FIG. 9, the acceptance processing used by a doctor or provider 08 is shown. At step 80, the doctor uses management system 01, via a communications device, to view the items which the representative desires to transfer to this doctor. At step 82, the doctor selects one or more of these lots to review. At decision block 84, the doctor can decide to reject all of them and exit, or at block 88 to edit the list and reject some at step 90, or simply to accept all or all remaining at step 92. System supplied identifiers 22a on each item are then scanned at step 94 to confirm receipt of the item and authorize its entry into the doctor's inventory at step 96 by signing electronically in one of the methods described above. As part of this authorization, the health care provider enters his or her password and signature to accept custody of the transferred lot.

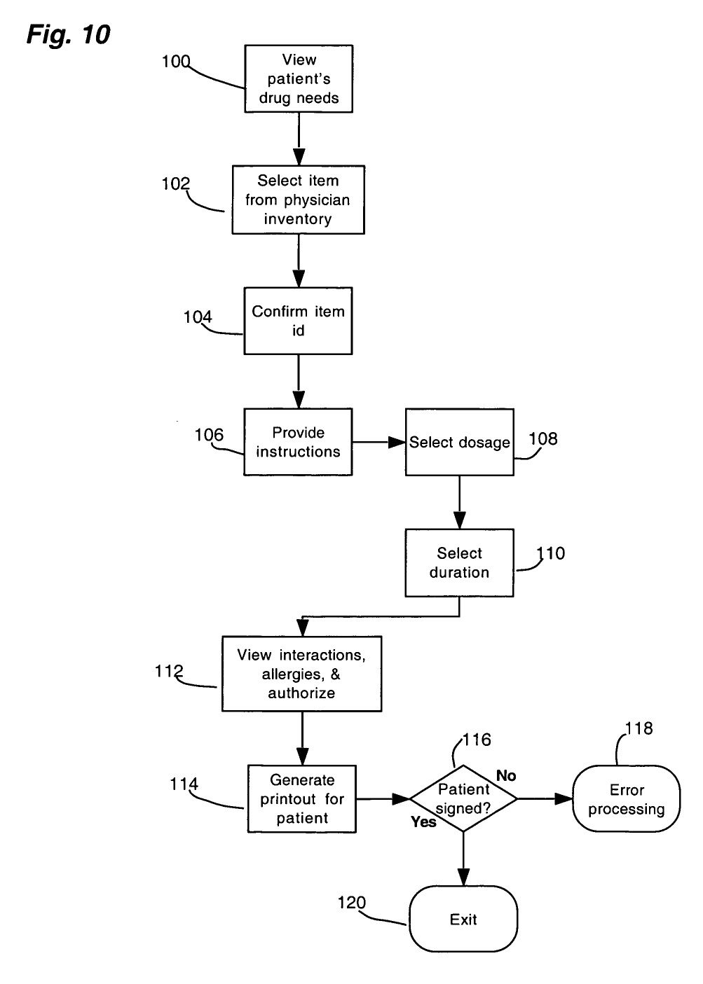

FIG. 10 illustrates the procedure for tracking custody of the pharmaceutical item through dispensation to a patient. At step 100, the doctor views a patient's likely prescription needs, and deciding upon a drug sample, at step 102 the physician looks at his or her own inventory of those items and selects one or more from inventory. It is an aspect of the present invention that part of this process enables the doctor to check a proposed prescription drug against the formulary that patient's health insurance provider uses Thus, the physician can check to see whether a proposed drug sample about to be prescribed will be covered by that patient's insurer. If it is, this selection is confirmed in FIG. 10 at step 104, by scanning in the unique identifier 22a using the handheld PDA 12 or the physician's computer 14. Once the sample Identifier has been confirmed, management system 01 will provide the physician with instruction data at step 106, so that the physician can select a dosage at step 108 and a duration at step 110.

Still in FIG. 10, at step 112, management system 01 enables the physician to view any relevant drug interactions or patient allergies detected by the system, and if no problems are found, the physician will typically authorize the prescription of this drug and the provision of this sample at step 112 as well. After that, management system 01 will print out and/or display instructions for the patient at step 114, using information and warning data provided for that drug in database 04. At decision block 116, management system 01 will prompt the physician to see if the patient has signed electronically to acknowledge receiving and understanding the instructions. If the patient has signed, that signature is stored and processing exits at step 120. If the patient has not signed, the system allows the doctor to handle this at step 122.

At this point, management system 01's custody module has provided a complete chain of custody for a specific pharmaceutical item, from the time the item was transferred into the system, allocated to a representative, transferred to a doctor, to the time the item was given to a patient in the doctor's office. In addition, by providing an electronic signature capability, management system 01 has also provided stored evidence that the patient was given the proper instructions for the medication in that specific item and acknowledged receipt and reading of them.

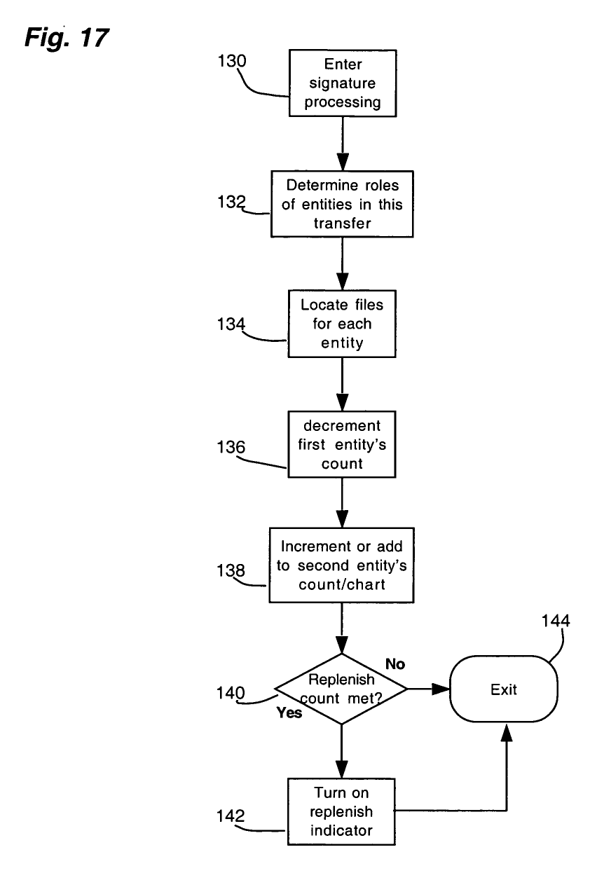

As can be seen in FIG. 17, management system 01's custody module also provides processing for most of the inventory functions of the system as well at the time that pharmaceutical items are accepted by an electronic signature. Each time a signature is entered in management system01 to confirm a transfer from one entity to another, management system 01 performs inventory processing, starting at step 130. At step 132, management system 01 determines the roles and identities of the two entities involved in the transfer or uses those already provided to it during earlier processing. For example, if the transfer is from a doctor to a patient, these identities and roles have already been provided in the processing described in FIG. 10, above. Returning to FIG. 17, using those identities and roles, management system 011 locates the appropriate files for each entity. For the doctor, this will be an inventory file and for the patient, this will be the patient's electronic “chart” file. If the transfer had occurred between the pharmaceutical representative and the doctor, the files would be each entity's respective inventory file. At step 136, management system 01 will decrement the first entity's inventory file by the number of items transferred in this transaction and at step 138, the system will increment the receiving entity's inventory file by that amount. If the second entity is a patient, the patient's electronic “chart” will be updated to reflect receipt of the amount transferred. Optionally, management system 01 can also provided a printed confirmation of this for the patient's hard copy chart. At decision block 140, management system 01 checks to see if the transfer from the first entity's inventory meets any replenishment levels requested by that entity, and if it does, at step 142 a replenish indicator is turned on. Processing exits at step 144.

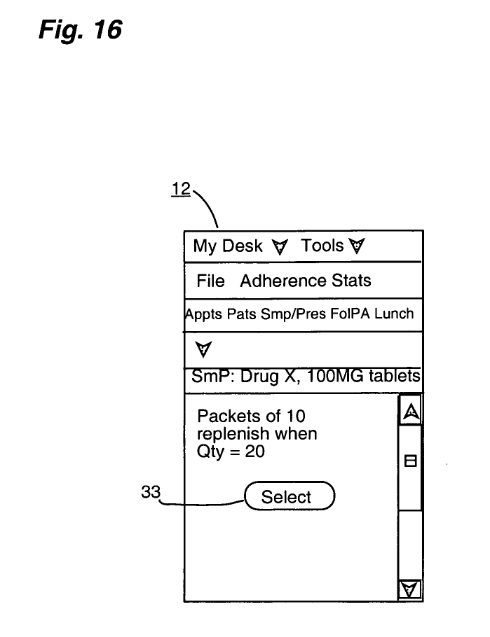

With reference now to FIG. 16, the inventory functions of management system 01 also include a replenishment indicator, by which a provider 08 can specify that he or she wishes to receive more samples of a particular drug if inventory supplies fall below a specified level. Note that this is not a typical reorder feature, since a health care provider usually does not order samples—they are distributed free of charge by pharmaceutical manufacturers, and hence are not directly orderable. However, most pharmaceutical manufacturers like to know if samples are being used and if providers want more of them. The replenishment indicator of the present invention provides the information to a manufacturer or a representative without the need for the representative to make a special visit. This provides a significant benefit to all concerned. This ability means that a sales representative does not need to make as many calls as he or she might have heretofore, since the physician's use of management system 01 makes it easy to know when new samples are needed. This, in turn, saves time for the physician and staff, who don't need to attend as many luncheon appointments to learn about samples from the representative. The manufacturer, of course, benefits by having a more accurate indication of which samples are being used and that replenishment is desired. Patients also benefit as those who need free samples for economic reasons are more likely to have them made available with such an inventory approach. In addition to the replenishment indicator, if the health care provider is a clinic or hospital that normally order drugs in quantity, the replenishment indicator can also be used as an automatic reorder feature if the health care provider so specifies.

In addition, it is an aspect of the present invention that its custody and inventory functions operate in what is substantially real-time for all practical purposes. This means that timely information is available instantly for all concerned. In the past, information about sample or drug usage might only be available to a manufacturer two or three months after a prescription had been written or a sample given out. Prior to the present invention, pharmaceutical manufacturers had to rely on purchased lists of prescription data obtained from pharmacy chains. These lists contained data that was two or three months old—or more—by the time the pharmaceutical manufacturer obtained them. The present invention enables a manufacturer to detect seasonal trends in supply and demand in a time frame that makes it more feasible for the manufacturer to adapt to such trends.

Additionally, the present invention significantly changes the interactions between a pharmaceutical manufacturer and a health care provider in several ways. First, it saves time for all concerned—the manufacturer gets up to date, current information about sample and drug usage; the representative can be more effective in reaching more health care providers in less time, and the health care provider needs to spend less time meeting with representatives to get the same or better benefits for his or her patients. In the past, the pharmaceutical manufacturer was essentially using a “push model” to encourage health care providers to try samples of new drugs. The inventory and replenishment features of the present invention, now make the relationship between the manufacturer and the health care provider much more that of a “pull model”, in that the provider can indicate when replenishment is desirable and to what degree.

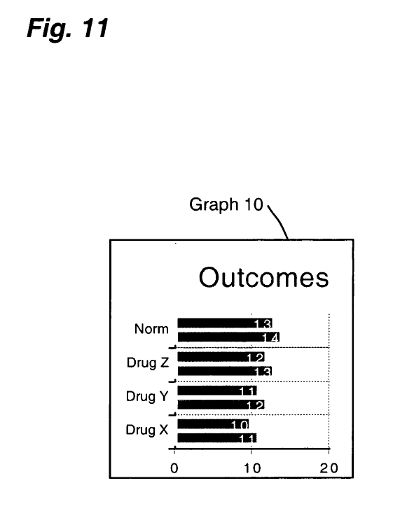

With reference now to FIG. 11, an illustrative outcomes graph 10 is shown. In the embodiments shown, management system 01 enables health care providers to evaluate the efficacy of treatments prescribed by comparing results of a given drug against a norm or results from another drug. In graph 10, a norm is shown, and the efficacy of three different drugs in getting patients closer to this norm is depicted.

The present invention is written using CGI scripts and XML to produce screen displays for browsers used in conventional computers as well as PDA and cell phones. Those skilled in the art will appreciate that other languages and display techniques can be used without deviating from the present invention. Additionally, the present invention is implemented on computer systems using the Windows® operating system from Microsoft corporation and Pocket PC operating systems for PDAs. As will be apparent to those skilled in the art, other computer and PDA operating systems can be used without deviating from the present invention. Further, while the embodiments shown are implemented in software using the devices mentioned in the above specification, those skilled in the art will also appreciate that some or all of the functions of the present invention could also be implemented in firmware or hardware without deviating from the present invention.

What is claimed is:

1. A system for managing information about pharmaceuticals, patients, and health care providers, comprising
a database for storing pharmaceutical data and patient data;
a communications device capable of reading identifiers, displaying data, and receiving electronic signatures;
a communications pathway;
a management system capable of communicating with the communications device over the communications pathway and with the database, the management system supplying an identifier to be used on a readable label attached to an item such that the identifier can be read by the communications device.

2. The system of claim 1, wherein the item further comprises a pharmaceutical item being transferred from a first entity to a second entity wherein the communications device is capable of receiving a signature of the second entity indicative of the transfer.

3. The system of claim 1, wherein the item further comprises a patient chart containing information about a patient.

4. The system of claim 2, wherein the first entity further comprises a pharmaceutical manufacturer and the second entity further comprises a pharmaceutical representative.

5. The system of claim 2, wherein the first entity further comprises a pharmaceutical representative and the second entity further comprises a health care provider.

6. The system of claim 2, wherein the first entity further comprises a health care provider and the second entity further comprises a patient.

7. The system of claim 2, wherein the pharmaceutical item further comprises a pharmaceutical sample.

8. The system of claim 2, wherein the pharmaceutical item further comprises an injectable item.

9. The system of claim 1, wherein the readable label further comprises a barcode label containing the system supplied identifier in barcode form.

10. The system of claim 1, wherein the readable label further comprises a radio frequency label containing the system supplied identifier in radio frequency form.

11. The system of claim 1, wherein the communications device is a personal digital assistant.

12. The system of claim 1, wherein the communications device is a personal computer.

13. The system of claim 1, wherein the communications device is a cellular telephone.

14. The system of claim 2, wherein the electronic signature further comprises an electronic signature created by use of a stylus.

15. The system of claim 2, wherein the electronic signature further comprises an electronic signature created by use of a wireless technology pen.

16. The system of claim 3, wherein the patient data further comprises diagnostic, clinical, and treatment data about the patient.

17. The system of claim 2, wherein the management system further comprises a chain of custody program for logging any transfers of the pharmaceutical item.

18. The system of claim 2, wherein the management system further comprises an inventory program for keeping track of the pharmaceutical item and providing a replenishment indicator.

19. The system of claim 6 wherein the management system further comprises a formulary checking program for determining whether a proposed pharmaceutical is covered by the patient's medical insurer.

20. The system of claim 6, wherein the management system further comprises an informed consent program which identifies any drug interaction and instruction information relevant to a proposed prescription, provides the information in readable form to the patient, and stores the patient's electronic signature confirming receipt of same.

21. The system of claim 20, wherein the management system further comprises an electronic prescription writer which automatically generates a prescription upon authorization by the health care provider and transmits it.

22. The system of claim 6, wherein the management system further comprises a primary diagnosis indicator for displaying at least one primary diagnosis for a patient whenever that patient's information is being viewed by the health care provider.

23. The system of claim 1, wherein the management system further comprises a transaction logging function to permanently record and identify designated transactions.

24. The system of claim 16, wherein the management system further comprises a patient record program that associates the identifier from the patient's chart with stored patient data in the database.

25. The system of claim 24, wherein the management system further comprises an adherence data gatherer which collects and displays clinical information about the patient stored in the database, the information being indicative of the patient's compliance with a prescribed treatment.

26. The system of claim 24, wherein the management system further comprises a network analysis program for analyzing reactions of a specified group of patients stored in the database to prescribed treatments and reporting the results without divulging any patient identifying data.

27. The system of claim 24, wherein the management information system further comprises a clinical response analyzer which compares patient data stored in the database to standard response data stored in the database for prescribed treatments to determine whether the patient is responding as expected.

28. The system of claim 24, wherein the management information system further comprises an outcomes analyzer for comparing patient data for patients having the same diagnosis but at least two different prescribed treatments and summarizing the outcomes.

29. A method for managing information about pharmaceuticals, patients, and health care providers, comprising the steps of:
storing pharmaceutical data and patient data in a database;
communicating with a communications device capable of reading identifiers, displaying data, and receiving electronic signatures;
signaling over a communications pathway;
managing information through a management system capable of communicating with the communications device of the communications pathway and with the management system supplying an identifier for an item to be used on a readable label attached to the item such that the identifier can be read by the communications device.

30. The method of claim 29, wherein the step of supplying an identifier for an item further comprises the step of supplying an identifier for a pharmaceutical item being transferred from a first entity to a second entity so that a signature of the second entity can be received by the communications device when the second entity acknowledges the transfer.

31. The method of claim 29, wherein the step of supplying an identifier for an item further comprises the step of supplying an identifier for a patient chart.

32. The method of claim 30, wherein the step of supplying an identifier for a pharmaceutical item being transferred from a first entity to a second entity further comprises the step of recognizing the first entity as a pharmaceutical manufacturer and the second entity as a pharmaceutical representative.

33. The method of claim 30, wherein the step of supplying an identifier for a pharmaceutical item being transferred from a first entity to a second entity further comprises the step of recognizing the first entity as a pharmaceutical representative and the second entity as a health care provider.

34. The method of claim 30, wherein the step of supplying an identifier for a pharmaceutical item being transferred from a first entity to a second entity further comprises the step of recognizing the first entity as a health care provider and the second entity as a patient.

35. The method of claim 30, wherein the step of supplying an identifier for pharmaceutical item further comprises the step of supplying an identifier for a pharmaceutical sample.

36. The method of claim 30, wherein the step of supplying an identifier for a pharmaceutical item further comprises the step of supplying an identifier for an injectable item.

37. The method of claim 29, wherein the step of supplying an identifier for an item further comprises the step of supplying the identifier as a barcode.

38. The method of claim 29, wherein the step of supplying an identifier for an item further comprises the step of supplying the identifier as a radio frequency identifier.

39. The method of claim 29, wherein the step of communication with a communications device further comprises the step of communicating with a personal digital assistant.

40. The method of claim 29, wherein the step of communicating with a communications device further comprises the step of communicating with a personal computer.

41. The method of claim 29, wherein the step of communicating with a communications device further comprises the step of communicating with a cellular telephone.

42. The method of claim 29, wherein the step of receiving an electronic signature further comprises the step of receiving an electronic signature created using a stylus.

43. The method of claim 29, wherein the step of receiving an electronic signature further comprises the step of receiving an electronic signature created using a wireless technology pen.

44. The method of claim 31, wherein the step of supplying an identifier for a patient chart further comprises the step of associating the identifier with diagnostic, clinical, and treatment data about the patient and storing it in the database.

45. The method of claim 30, wherein the step of supplying an identifier for a pharmaceutical item further comprises the step of logging any transfers of the pharmaceutical item.

46. The method of claim 30, wherein the step of managing information further comprises the step of tracking the inventory of the pharmaceutical item and providing a replenishment indicator.

47. The method of claim 29, wherein the step of managing information further comprises the step of determining whether a proposed pharmaceutical is covered by the patient's medical insurer.

48. The method of claim 30, wherein the step of managing information further comprises the steps of locating any drug interaction and instruction information relevant to a proposed prescription and providing this drug interaction and instruction information in readable form to the patient and storing in the database the patient's electronic signature confirming receipt of said drug interaction and instruction information.

49. The method of claim 48, wherein the step of managing information further comprises the step of automatically generating a prescription upon authorization by the health care provider and transmitting it.

50. The method of claim 34, wherein the step of managing information further comprises the step of displaying a diagnosis showing at least one primary diagnosis for a patient whenever that patient's information is being viewed by the health care provider.

51. The method of claim 29, wherein the step of managing information further comprises the step of logging transactions to permanently record and identify designated transactions.

52. The method of claim 44, wherein the step of managing information further comprises the step of associating the identifier from the patient's chart with stored patient data in the database.

53. The method of claim 52, wherein the step of managing information further comprises the step of collecting and displaying clinical information about the patient stored in the database, the information being indicative of the patient's compliance with a prescribed treatment.

54. The method of claim 52, wherein the step of managing information further comprises the steps of analyzing reactions of a specified group of patients stored in the database to prescribed treatments using a network analysis program and reporting the results without divulging any patient identifying data.

55. The method of claim 52, wherein the step of managing information further comprises the step of comparing patient data stored in the database to standard response data stored in the database for prescribed treatments to determine whether the patient is responding as expected.

56. The method of claim 52, wherein the step of managing information further comprises the step of comparing data for patients having the same diagnosis but having at least two different prescribed treatments and summarizing the outcomes.

57. A machine readable medium for storing a system for managing information about pharmaceuticals, patients, and health care providers, comprising a database for storing pharmaceutical data and patient data; communications device support, capable of supporting communications devices for reading identifiers, displaying data, and receiving electronic signatures; a communications pathway; a management system capable of communicating with the communications device over the communications pathway and with the database, the management system supplying an identifier to be used on a readable label attached to an item such that the identifier can be read by the communications device.
